(19) United States
(12) Patent Application Publication
(10) Pub. No.: US 2009/0250986 A1
(43) Pub. Date: Oct. 8, 2009

(54) SEAT ARRANGEMENT FOR A MOTOR VEHICLE HAVING A LONGITUDINALLY DISPLACEABLE MIDDLE VEHICLE SEAT

(75) Inventors: Juergen MAIER, Weitersweiler (DE); Jens Winter, Gau-Bischofsheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/419,847

(22) Filed: Apr. 7, 2009

(30) Foreign Application Priority Data
Apr. 8, 2008 (DE) 102008017710.5

(51) Int. Cl. B60N 2/01; B60N 2/04; B60N 2/20

(52) U.S. Cl. 297/257

(57) ABSTRACT

A seat arrangement is provided for a motor vehicle having two outer vehicle seats and a middle vehicle seat disposed between the outer vehicle seats in the transverse direction, which are displaceable independently of one another in the longitudinal direction. The middle vehicle seat has a folding backrest and can be brought from a seat position in which the backrest is aligned substantially upright into an armrest position in which the backrest is aligned substantially horizontally and can be used at least partially as an armrest for at least one of the outer vehicle seats. The middle vehicle seat has a first actuator and a second actuator for displacement of the middle vehicle seat in the longitudinal direction. At the same time, the middle vehicle seat can be displaced in the longitudinal direction by actuating one of the actuators.

### CROSS-REFERENCE TO RELATED APPLICATION

This application claims priority to German Patent Application No. 102008017710.5, filed Apr. 8, 2008, which is incorporated herein by reference in its entirety.

### TECHNICAL FIELD

The present invention relates to a seat arrangement for a motor vehicle having two outer vehicle seats and a middle vehicle seat disposed between the outer vehicle seats in the transverse direction, which are displaceable independently of one another in the longitudinal direction, and the middle vehicle seat has a folding backrest and can be brought from a seat position in which the backrest is aligned substantially upright into an armrest position in which the backrest is aligned substantially horizontally and can be used at least partially as an armrest for at least one of the outer vehicle seats.

### BACKGROUND

Known from the prior art are a plurality of seat arrangements in which three vehicle seats are disposed adjacent to one another in the transverse direction in a seat row of the motor vehicle. For example, EP 1 728 677 A1 describes such an arrangement in which the middle vehicle seat has a folding backrest. The folding backrest can be folded or pivoted from a substantially upright position into a substantially horizontally aligned position. In the last-mentioned position, the backrest or a part of the backrests serves as an armrest for one of the adjacent vehicle seats in the same seat row. In the known seat arrangement, the middle vehicle seat can merely be displaced in the longitudinal direction together with one of the outer vehicle seats with the result that flexible usage of the known seat arrangement is only possible to a limited extent.

DE 197 42 408 B4 describes a similar seat arrangement with three vehicle seats, which are disposed in a common seat row. In contrast to the previously described seat arrangement, the middle vehicle seat of this seat arrangement can be displaced independently of the two outer vehicle seats in the longitudinal direction of the motor vehicle. This goes so far that, starting from the said seat row, the middle vehicle seat can be displaced between the two outer vehicle seats of another seat row. As a result, particularly flexible usage of the known seat arrangement is possible. In this case, the forward-folded backrest of the middle vehicle seat can also serve as an armrest for a vehicle occupant on one of the outer vehicle seats within the seat row.

Another seat arrangement with three vehicle seats within a seat row is further described in EP 0 943 B1. In the known seat arrangement the backrest of the middle vehicle seat has wing rests, which after the backrest has been folded forward, can be pivoted from a lower armrest non-usage position into an upper armrest usage position in which the wing rests form an armrest for the adjacent vehicle seats. All three vehicle seats can be displaced independently of one another in the longitudinal direction, in addition the outer vehicle seats can be further displaced in the transverse direction so that this seat arrangement allows particularly flexible usage and adaptation to the wishes of the vehicle occupants.

The seat arrangements known from the prior art have proved successful but are disadvantageous insofar as handling of the middle vehicle seat by a vehicle occupant on another vehicle seat is difficult, particularly during the longitudinal displacement of the middle vehicle seat when the backrest is located in the forward-folded position.

It is therefore at least one object of the present invention to provide a seat arrangement for a motor vehicle in which the handling of the middle vehicle seat particularly during displacement of the same in the longitudinal direction is simplified. In addition, other objects, desirable features, and characteristics will become apparent from the subsequent summary and detailed description, and the appended claims, taken in conjunction with the accompanying drawings and this background.

### SUMMARY

The seat arrangement according to an embodiment of the invention is designed for a motor vehicle but can also be used in other means of transport. The seat arrangement comprises two outer vehicle seats and a middle vehicle seat, the middle vehicle seat being disposed between the outer vehicle seats in the transverse direction. The vehicle seats are displaceable independently of one another in the longitudinal direction so particularly flexible usage of the seat arrangement is possible. The longitudinal direction is to be understood here both as the seat direction and also that direction which is opposite to the seat direction, and the transverse direction describes the two directions traverse to the seat direction. The middle vehicle seat has a folding backrest. The backrest can be folded from a substantially upright position into a substantially horizontal position. When the backrest is in the upright position, the middle vehicle seat is in the seat position in which a vehicle occupant can be seated on the middle vehicle seat. When the backrest is folded into the substantially horizontal position, the middle vehicle seat is located in the so-called armrest position in which the backrest can be used at least partially as an armrest for at least one of the other vehicle seats. The middle vehicle seat has a first actuator and a second actuator for displacement of the middle vehicle seat in the longitudinal direction, and the middle vehicle seat can be displaced in the longitudinal direction by actuating one of the actuator (which shall also be referred to as actuating means).

This seat arrangement has the advantage that a vehicle occupant can decide on that one of the two actuating means which is easier for him to reach according to the position of the backrest of the middle vehicle seat in order to displace the middle vehicle seat in the longitudinal direction. The two actuating means could thus be disposed in such a manner on the middle vehicle seat that in the seat position of the middle vehicle seat, the first actuating means is easier for the vehicle occupant on this middle vehicle seat to reach, whereas in the armrest position of the middle vehicle seat, the other actuating means can be reached more easily by the vehicle occupant on one of the outer vehicle seats. The handling of the seat arrangement is thereby permanently simplified.

In a preferred embodiment of the seat arrangement according to the invention, the locking of the middle vehicle seat in the longitudinal direction can be released by actuating one of the actuating means.

In order to simplify the handling of the seat arrangement, particularly when displacing the middle vehicle seat in the longitudinal direction, in a further preferred embodiment of the seat arrangement according to the invention, the actuating means are disposed on the middle vehicle seat in such a manner that the first actuating means in the seat position of the middle vehicle seat and the second actuating means in the armrest position of the middle vehicle seat can be reached more rapidly by a vehicle occupant on one of the outer vehicle seats. Thus, the two actuating means can be disposed, for example, in such a manner on the middle vehicle seat that these are only accessible or reachable in the respective position of the middle vehicle seat.

In a particularly preferred embodiment of the seat arrangement according to the invention, the first actuating means is provided at the front and the second actuating means is provided at the back on the middle vehicle seat. Thus, the first actuating means can be actuated particularly easily by the vehicle occupant sitting on the middle vehicle seat whereas the second actuating means can be actuated particularly easily by one of the vehicle occupants on one of the outer vehicle seats when the middle vehicle seat is located in the armrest position.

In an advantageous embodiment of the seat arrangement according to the invention, the middle vehicle seat has a seat portion on which the vehicle occupant can be seated.

In order to allow particularly good reachability of the first actuating means by the vehicle occupant on the middle vehicle seat, in a further advantageous embodiment of the seat arrangement according to the invention, the first actuating means is disposed on and/or below a frontward-pointing section of the seat portion in the seat direction.

In order to ensure particularly good reachability of the second actuating means by one of the vehicle occupants on one of the outer vehicle seats in the armrest position of the middle vehicle seat, in a further particularly advantageous embodiment of the seat arrangement according to the invention, the second actuating means is disposed on and/or below a rearward-pointing section of the seat portion contrary to the seat direction. After folding or pivoting the backrest into the substantially horizontally aligned position, the second actuating means is therefore particularly easy to reach for a vehicle occupant on one of the outer vehicle seats.

In order to reinforce the aforesaid advantage, in a particularly preferred embodiment of the seat arrangement according to the invention, the second actuating means projects beyond the rearward-point section of the seat portion contrary to the seat direction.

In order to prevent unintentional actuation of the second actuating means by a vehicle occupant on one of the rear rows of seats, in a further particularly preferred embodiment of the seat arrangement according to the invention, the second actuating means in the seat position of the middle vehicle seat is covered from above by the backrest and is no longer covered from above in the armrest position of the middle vehicle seat. In this way, the second actuating means is only particularly easily accessible when the backrest has been pivoted into the horizontal position or the middle vehicle seat has been brought into the armrest position.

In a further advantageous embodiment of the seat arrangement according to the invention, the actuating means is a handle, said handle preferably being configured in the manner of a loop. Thus, for example, the first actuating means could be configured as a rigid handle while the second actuating means can be configured as a flexible loop.

In order to ensure that the first actuating means can be reached particularly easily by the vehicle occupant on the middle vehicle seat when the middle vehicle seat is located in the seat position and that the second actuating means can be reached particularly rapidly and easily by a vehicle occupant on one of the outer vehicle seats when the middle vehicle seat is located in the armrest position, in a further particularly preferred embodiment of the seat arrangement according to the invention, the first and/or second actuating means is disposed centrally on the middle vehicle seat relative to the transverse direction. Thus, the two vehicle occupants on the two outer vehicle seats can reach the second actuating means equally rapidly and reliably in order to displace the middle vehicle seat in the longitudinal direction. The handling of the seat arrangement is substantially simplified as a result.

In a further advantageous embodiment of the seat arrangement according to the invention, a rail arrangement is provided for displacement and a locking mechanism is provided for locking the middle vehicle seat in the longitudinal direction, and the locking mechanism can be actuated with the aid of the first or second actuating means. Thus, the locking mechanism can, for example, effect a locking of the rail arrangement, and the locking could be released by actuating one of the actuating means. Reference may also be made to the prior art with regard to the rail arrangement and the locking mechanism.

In a further particularly advantageous embodiment of the seat arrangement according to the invention, the middle vehicle seat can be displaced in the longitudinal direction both in the seat position and in the armrest position. This has the particular advantage that a displacement of the armrest for the two outer seats in the longitudinal direction can be achieved simply by a displacement of the middle vehicle seat in the longitudinal direction without a separate displacement mechanism needing to be provided for that part of the backrest which forms the armrest. A particularly simple structure of the middle vehicle seat and therefore of the entire seat arrangement is achieved by this means.

In a further advantageous embodiment of the seat arrangement according to the invention, the backrest has at least one wing rest which, in the armrest position of the middle vehicle seat can be pivoted from a lower armrest non-usage position about a pivot axis extending in the longitudinal direction into an upper armrest usage position to form an armrest. In this way, the wing rest can form a particularly high armrest for one of the two outer vehicle seats.

In order to be able to provide a particularly high armrest for the one outer vehicle seat and for the other outer vehicle seat, the middle vehicle seat has two wing rests of the said type each disposed in a transverse direction on a middle armrest portion of the armrest.

In a further advantageous embodiment of the seat arrangement according to the invention, the outer vehicle seats can further be displaced in the transverse direction, with the result that a particularly flexible adaptation of the seat arrangement is possible.

In a further particularly advantageous embodiment of the seat arrangement according to the invention, at least one of the outer vehicle seats can be displaced inward in the transverse direction in such a manner that this extends at least partly into the free space which was created by the pivoting of the wing rest from the armrest non-usage position into the armrest usage position. In this embodiment, the width of the backrest of the middle vehicle seat, reduced by pivoting the wing rests into the armrest usage position, can thus be used to reduce the overall width of the seat arrangement by displacing one of the outer vehicle seats inward in the transverse direction. This may be necessary depending on the surroundings of the seat arrangement if, for example, the outer vehicle seats are to be displaced in the longitudinal direction into an area of the motor vehicle which has a smaller width.

### BRIEF DESCRIPTION OF THE DRAWINGS

The present invention will hereinafter be described in conjunction with the following drawing figures, wherein like numerals denote like elements, and:

FIG. 1 shows a front view of the seat arrangement according to an embodiment of the invention with the middle vehicle seat in the seat position;

FIG. 2 shows a side view of the seat arrangement from FIG. 1 in cutaway view;

FIG. 3 shows the seat arrangement from FIG. 1 with the middle vehicle seat in the armrest position;

FIG. 4 shows a side view of the seat arrangement from FIG. 3 in cutaway view;

FIG. 5 shows the seat arrangement from FIG. 3 with the wing rests in the armrest usage position;

FIG. 6 shows a side view of the seat arrangement from FIG. 5 in cutaway view; and

FIG. 7 shows the seat arrangement from FIG. 5 with the outer vehicle seats displaced in the transverse direction.

### DETAILED DESCRIPTION

The following detailed description is merely exemplary in nature and is not intended to limit application and uses. Furthermore, there is no intention to be bound by any theory presented in the preceding background and summary or the following detailed description.

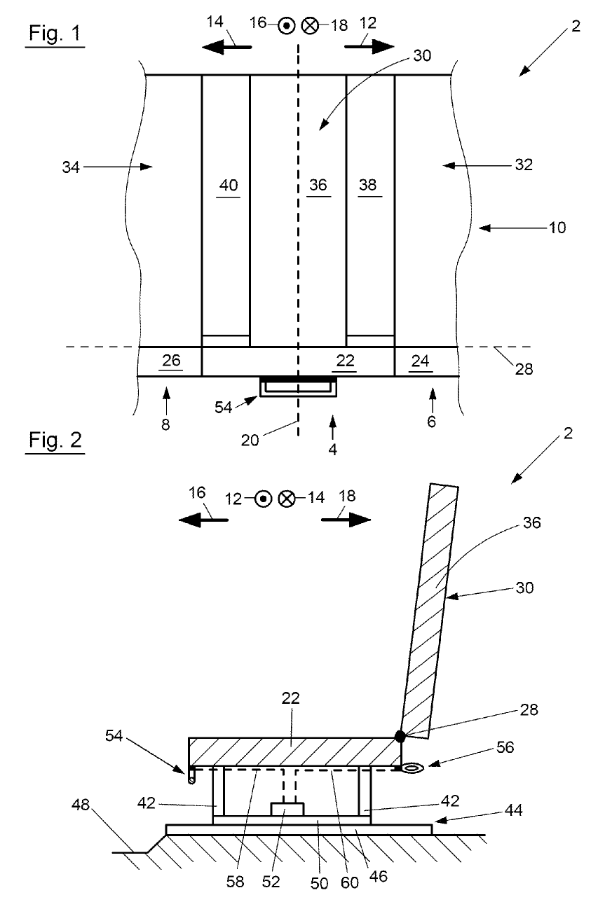

FIG. 1 shows a front view of the seat arrangement 2 according to an embodiment of the invention, whereas FIG. 2 shows a side view of the seat arrangement 2 from FIG. 1 in cutaway view. The seat arrangement 2 comprises a middle vehicle seat 4 and two outer vehicle seats 6, 8. The vehicle seats 4, 6, 8 are disposed in a seat row 10, and the outer vehicle seat 6 is disposed in the transverse direction 12 adjacent to the middle vehicle seat 4 and the other outer vehicle seat 8 is disposed in the opposite second transverse direction 14 adjacent to the middle vehicle seat 4. The two longitudinal directions of the seat arrangement 2 are indicated by the arrows 16 and 18, and the first longitudinal direction 16 corresponds to the seat direction of the vehicle seats 4, 6, 8. In addition, the height direction 20 of the seat arrangement 2 of the vehicle seats 4, 6, 8 is indicated by means of a dashed vertical axis in FIG. 1.

The vehicle seats 4, 6, 8 each comprise a seat portion 22, 24, 26 on which a vehicle occupant can be seated and a backrest 30, 32, 34 disposed pivotably about a first pivot axis 28 on the respective seat portion 22, 24, 26. The backrests 30, 32, 34 can be pivoted about the pivot axis 28 independently of one another. The backrest 30 of the middle vehicle seat 4 is substantially composed of a middle backrest portion 36 and two wing rests 38, 40 fastened laterally thereon. Whereas the wing rest 38 is disposed laterally on the middle backrest portion 36 in transverse direction 12, and is thus facing the outer vehicle seat 6, the wing rest is disposed laterally on the middle backrest portion 36 in the transverse direction 14 and therefore facing the outer vehicle seat 8.

The vehicle seats 4, 6, 8 can be displaced independently of one another in the longitudinal directions 16 and 18. For this purpose the middle vehicle seat 4 has an underframe on its seat portion 22 which is indicated by means of the struts 42 in FIG. 2. For displacement of the middle vehicle seat 4 in the longitudinal direction 16 or 18, there is provided a rail arrangement 44 which comprises at least one guide rail 46 on the vehicle floor 48 and a guide rail 50 guided on the guide rail 46 on the underframe of the middle vehicle seat 4. So that the middle vehicle seat 4 can be locked in various positions in the longitudinal directions 16, 18, a schematically depicted locking mechanism 52 is provided for locking the middle vehicle seat 4 in the longitudinal direction 16, 18. The locking mechanism 52 can thereby be actuated with the aid of a first actuating means 54 or a second actuating means 56 so that the locking of the middle vehicle seat 4 in the longitudinal direction 16, 18 can be released by manual actuation of one of actuating means 54, 56. The cooperation between the actuating means 54, 56 is indicated merely schematically by means of dashed lines 58 or 60 in FIG. 2. Instead of the dashed lines 58, 60, mechanical transmission means such as, for example, a Bowden cable can be used.

The first actuating means 54 is configured as a handle in the form of a lever. In this case, the first actuating means 54 is provided at the front on the middle vehicle seat 54. For this purpose, the first actuating means 54 is disposed on and below a forward-pointing section of the seat portion 22 in the seat direction 16. The first actuating means 54 in this case does not project forward beyond the seat portion 22 in the seat direction 16 so as not to influence the leg room of a vehicle occupant on the middle vehicle seat 4. On the other hand, the second actuating means 56 is provided in longitudinal direction 18 at the back on the middle vehicle seat 4. The second actuating means 56 is thereby formed in the manner of a flexible loop and disposed on a rearward-pointing section of the seat portion in longitudinal direction 18. At the same time, the loop-shaped second actuating means 56 projects beyond the rearward-pointing section of the seat portion 22 in longitudinal direction 18 (i.e., contrary to the seat direction 16), as can be seen in FIG. 2. Both actuating means 54, 56 are disposed centrally on the middle vehicle seat 4 in relation to the transverse directions 12, 14, as can be seen from FIG. 1 with reference to the first actuating means 54.

In FIG. 1 and FIG. 2 the backrest 30 of the middle vehicle seat 4 is aligned substantially upright so that the middle vehicle seat 4 is located in the so-called seat position. In the seat position a vehicle occupant can be seated on the seat portion 22 of the middle vehicle seat 4 and lean against the backrest 30. In order to now displace the middle vehicle seat 4 independently of the other vehicle seats 6, 8 in longitudinal direction 16, 18, the vehicle occupant must actuate one of the two actuating means 54, 56 so that the locking mechanism 52 is released and a longitudinal displacement is possible by means of the rail arrangement 44 of the middle vehicle seat 4.

Since the first actuating means 54 is disposed at the front on the middle vehicle seat 4, in the seat position of the middle vehicle seat 4, the first actuating means 54 can be reached substantially more easily and more rapidly for the vehicle occupants on the middle vehicle seat than is the case with the second actuating means 56. Consequently, the vehicle occupant on the middle vehicle seat 4 in the seat position will decide to actuate the first actuating means 54 in order to displace the middle vehicle seat 4 in longitudinal direction 16, 18. Even if a vehicle occupant on one of the outer vehicle seats 6, 8 wished to displace the unoccupied middle vehicle seat 4 in its seat position in the longitudinal direction 16, 18, he will also decide on the first actuating means 54 since this is substantially more rapidly accessible for him. This may be attributed, inter alia to the fact that the second actuating means 56 in the seat position of the middle vehicle seat 4 is covered by the backrest 30 of the middle vehicle seat 4 in the vertical direction 20 from above. The first actuating means 54 consequently in any case ensures a simple and rapid displacement of the middle vehicle seat 4 in longitudinal direction 16, 18 when this is located in the seat position.

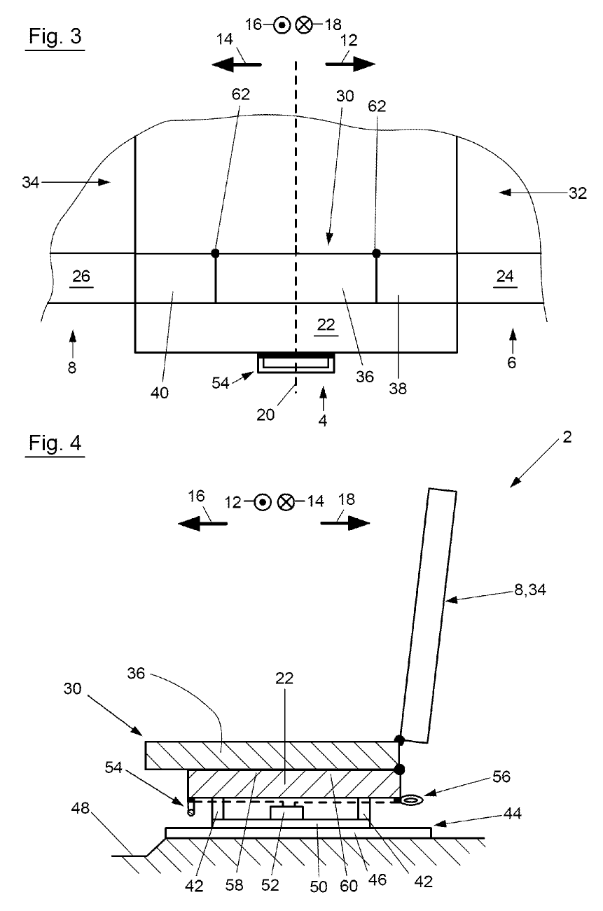

As has already been mentioned initially, the backrest 30 of the middle vehicle seat 4 can be pivoted about the first pivot axis 28 into a substantially horizontal position which is shown in FIG. 3 and FIG. 4. The middle vehicle seat 4 thus moves into an armrest position in which the backrest 30 can be partially used as an armrest for the outer vehicle seats 6, 8. In the armrest position of the middle vehicle seat 4, as shown in FIG. 3 and FIG. 4, the second actuating means 56 is no longer covered by the backrest 30 of the middle vehicle seat 4. Consequently, in the armrest position of the middle vehicle seat 4, the second actuating means 56 can be reached particularly easily by a vehicle occupant on one of the outer vehicle seats 6, 8 whereas the reachability of the first actuating means 54 is restricted because of the forward-pivoted backrest 30 of the middle vehicle seat 4. Should a vehicle occupant on one of the outer vehicle seats 6, 8 wish to displace the middle vehicle seat 4 in longitudinal direction 16, 18, he is no longer forced to use the front first actuating means 54 which he can only reach with difficulty. Rather, the vehicle occupant can grasp the second actuating means 56 particularly rapidly and easily in order to release the locking mechanism 52 and effect a longitudinal displacement of the middle vehicle seat 4 into its armrest position. The central arrangement of the second actuating means 56 on the middle vehicle seat 4 thereby ensures that the vehicle occupants on both outer vehicle seats 6, 8 can equally rapidly access the second actuating means 56.

From the preceding explanations, it is apparent that the middle vehicle seat 4 can be displaced in longitudinal direction 16, 18 both in its seat position and in its armrest position. Thus, a longitudinal adjustment of the armrest is possible for both the outer vehicle seats 6, 8 without a further displacement mechanism needing to be provided for the armrest.

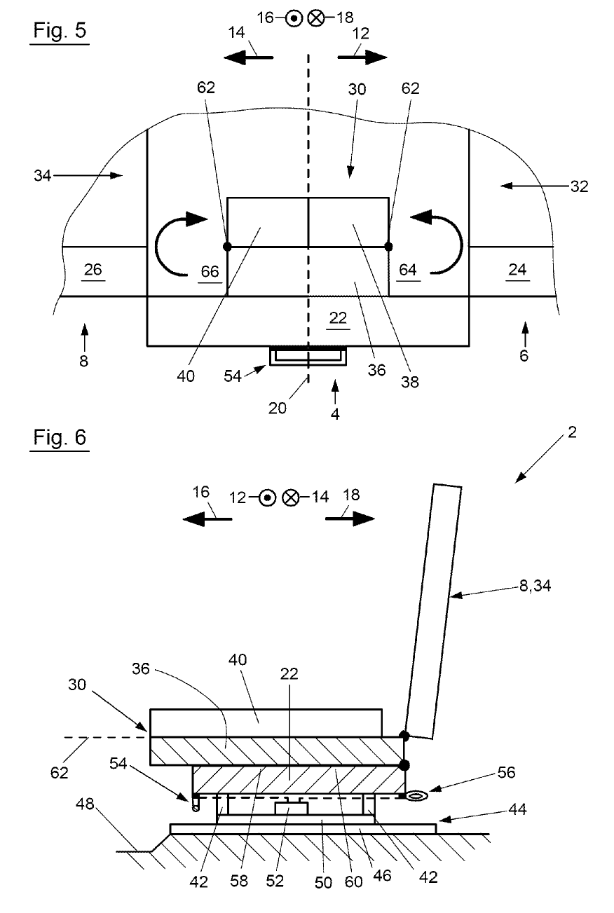

As is furthermore apparent from FIG. 3 and FIG. 4, during the pivoting of the backrest 30 of the middle vehicle seat 4, the seat portion 22 of the middle vehicle seat 4 has been lowered so far that its upper side is located below or at the same height as the underside of the seat portions 24, 26 of the neighboring outer vehicle seats 6, 8. As a result, the backrest 30 of the middle vehicle seat 4 in the armrest position of the same is lowered so far that this cannot form a sufficiently high armrest for one of the neighboring outer vehicle seats 6, 8. For this reason the wing rests 38, 40 in the armrest position of the middle vehicle seat 4 can be pivoted from a lower armrest non-usage position in which the wing rests 38, 40 can be used as an armrest only to a limited extent about a second pivot axis 62 extending in longitudinal direction 16 or 18 into an upper armrest usage position shown in FIG. 5 and FIG. 6. At the same time, the pivoted wing rests 38, 40 each leave a free space 64, 66 formed laterally of the middle backrest portion 36. In this armrest usage position of the wing rests 38, 40, the middle vehicle seat 4 can also be displaced in longitudinal direction 16, 18 in the previously described manner by actuating the second actuating means 56.

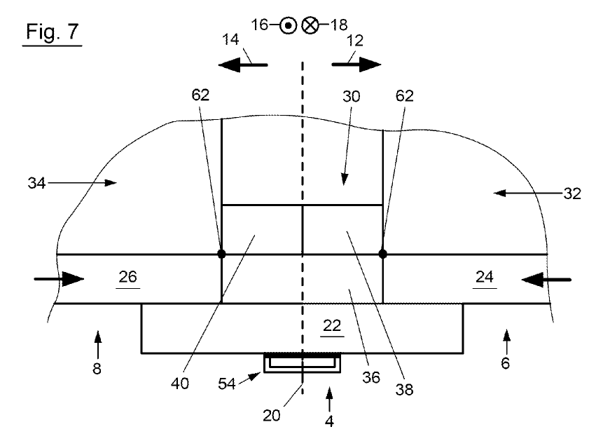

The two outer vehicle seats 6, 8 can be displaced not only in longitudinal direction 16, 18 but also in transverse direction 12, 14. The outer vehicle seats 6, 8 are thereby tuned to the middle vehicle seat 4 in such a manner that the outer vehicle seats 6, 8 can be displaced inward in transverse direction 14 or 13 and extend with their seat portion 24 or 26 into the free space 64 or 66 formed by the pivoting of the wing rests 38 or 40 from the armrest non-usage position into the armrest usage position shown in FIG. 5 to FIG. 7. In this position, the outer vehicle seats 6, 8 are disposed closer to the wing rests 38, 40 forming the armrests and the overall width of the seat row 10 or the seat arrangement 2 in the transverse direction 12, 14 is reduced. In this way the vehicle seats 4, 6, 8 can now be displaced in longitudinal direction 16 or 18 into an area of the motor vehicle which would otherwise be too narrow.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A seat arrangement for a motor vehicle, comprising:
at least two outer vehicle seats;
a middle vehicle seat disposed between the at least two outer vehicle seats in a transverse direction and displaceable independently of one another in a longitudinal direction,
wherein the middle vehicle seat has a folding backrest and can be brought from a seat position in which the folding backrest is aligned substantially upright into an armrest position in which the folding backrest is aligned substantially horizontally and can be used at least partially as an armrest for at least one of the at least two outer vehicle seats,
wherein the middle vehicle seat has a first actuator and a second actuator for displacement of the middle vehicle seat in the longitudinal direction,
wherein the middle vehicle seat is displaceable in the longitudinal direction by actuating at least one of the first actuator or the second actuator.

2. The seat arrangement according to claim 1, wherein the locking of the middle vehicle seat in the longitudinal direction is releasable by actuating at least one of the first actuator or the second actuator.

3. The seat arrangement according to claim 1, wherein the first actuator and the second actuator are disposed on the middle vehicle seat in such a manner that the first actuator in the seat position of the middle vehicle seat and the second actuator in the armrest position of the middle vehicle seat can be reached by a vehicle occupant from at least one of the at least two outer vehicle seats.

4. The seat arrangement according to claim 1, wherein the first actuator is provided at the front and the second actuator is provided at the back on the middle vehicle seat.

5. The seat arrangement according to claim 1, wherein the middle vehicle seat has a seat portion.

6. The seat arrangement according to claim 5, wherein the first actuator is at least disposed on or below a frontward-pointing section of the seat portion in a seat direction.

7. The seat arrangement according to claim 5, wherein the second actuator is at least disposed on or below a rearward-pointing section of the seat portion contrary to a seat direction.

8. The seat arrangement according to claim 7, wherein the second actuator projects beyond a rearward-point section of the seat portion contrary to the seat direction.

9. The seat arrangement according to claim 1, wherein the second actuator in the seat position of the middle vehicle seat is covered from above by the folding backrest and is no longer covered from above in the armrest position of the middle vehicle seat.

10. The seat arrangement according to claim 1, wherein at least one of the first actuator or the second actuator is a handle configured in a loop.

11. The seat arrangement according to claim 1, wherein at least one of the first actuator or the second actuator is disposed centrally on the middle vehicle seat relative to the transverse direction.

12. The seat arrangement according to claim 1, wherein a rail arrangement is provided for displacement and a locking mechanism is provided for locking the middle vehicle seat in the longitudinal direction, wherein the locking mechanism can be actuated with an aid of at least one of the first actuator or the second actuator.

13. The seat arrangement according to claim 1, wherein the middle vehicle seat is displaceable in the longitudinal direction both in the seat position and in the armrest position.

14. The seat arrangement according to claim 1, wherein the folding backrest has at least one wing rest which, in the armrest position of the middle vehicle seat, is pivotable from a lower armrest non-usage position about a pivot axis extending in the longitudinal direction into an upper armrest usage position to form the armrest.

15. The seat arrangement according to claim 14, wherein the middle vehicle seat has two wing rests disposed in the transverse direction on a middle backrest portion of the folding backrest.

16. The seat arrangement according to claim 1, wherein the at least two outer vehicle seats are further displaceable in the transverse direction.

17. The seat arrangement according to claim 16, wherein at least one of the at least two outer vehicle seats is displaceable inward in the transverse direction in such a manner that this extends at least partly into a free space which was created by the pivoting of at least one of the at least two wing rests from a non-usage position into an upper armrest usage position.
